(19) United States
(12) Patent Application Publication
(10) Pub. No.: US 2026/0049944 A1
(43) Pub. Date: Feb. 19, 2026

(54) ROTARY VALVE SEAL SHEET WEAR INDICATOR

(71) Applicant: UOP LLC, Des Plaines, IL (US)

(72) Inventors: Steven Lesniak, Chicago, IL (US); Robert Sanger, Mount Prospect, IL (US)

(21) Appl. No.: 19/066,392

(22) Filed: Feb. 28, 2025

Related U.S. Application Data
(60) Provisional application No. 63/683,764, filed on Aug. 16, 2024.

(51) Int. Cl. G01N 21/88; G01B 11/06

(52) U.S. Cl. CPC G01N 21/8803; G01B 11/06

(57) ABSTRACT

A seal sheet with one or more wear detecting sections. The wear detecting sections provide a way to determine the thickness of the seal sheet. The wear detecting sections comprise: a visually contrasting design element, wherein an amount of the visually contrasting design element increases or decreases during use: a groove having a width that changes during use; at least two grooves having different depth wherein the number of grooves visible changes during use, or combinations thereof.

### RELATED APPLICATIONS

This application claims priority to U.S. Provisional Patent Application Ser. No. 63/683,764, filed on Aug. 16, 2024, the entirety of which is incorporated herein by reference.

### BACKGROUND OF THE INVENTION

One method of separating a component or group of components from a mixture is selective adsorption on a solid adsorbent. One example of an adsorption process involves a continuous process in which feed and products enter and leave the adsorbent bed at substantially constant composition. In this process, the process simulates the countercurrent flow of a liquid feed over a solid bed of adsorbent without physically moving the solid by moving the injection and withdrawal points along the bed. As the concentration profile moves down the column, the injection and withdrawal points also move. The adsorbent-desorbent combination depends on the materials being separated. Other adsorbent processes using rotary valves are known to those of skill in the art.

FIG. 1 illustrates one example of an adsorption process. Separation occurs in the adsorbent chamber 10. The adsorbent chamber 10 is separated into a number of beds each of which has a flow distributor connected to the rotary valve 15. The flow distributors inject or withdraw liquid from the adsorbent chamber or redistribute liquid around the chamber. There are four major streams distributed to and from the adsorbent chamber 10 by the rotary valve 15. The feed inlet stream 20 includes a raw mixture of all of the feed components. A dilute extract out stream 25 includes a selectively adsorbed component or components diluted with desorbent. The dilute raffinate out stream 30 includes rejected components diluted with desorbent. The desorbent in stream 35 is the recycled desorbent separated from the extract and raffinate. Only four of the bed lines are carrying streams into or out of the adsorbent chamber 10 at any given time.

A pumparound pump 40 circulates process liquid from the adsorbent bed at the bottom of the adsorbent chamber 10 to the bed at the top. The concentration profile in the adsorbent chamber 10 moves down past the last bed, through the pumparound pump 40 and up to the top. The actual liquid flow rate through the zones is different because the rate of injection and withdrawal of the streams is different. The overall liquid circulation is controlled by the pumparound pump 40 and a flow control valve (not shown).

The rotary valve and its operation are described in U.S. Pat. Nos. 3,040,777 and 3,422,848, for example, which are incorporated herein by reference. The rotary valve includes two main parts: a moving rotor plate and a stationary track plate. The rotor plate sits on top of the track plate, and both are positioned in a pressure containing vessel, commonly called a dome. A seal sheet is secured to the bottom of the rotor plate between the tracks. In normal operation, the rotor plate is hydraulically seated on the track plate by introducing desorbent flow, or dome sealant, into the liquid filled dome. The dome pressure is maintained at a constant pressure during the entire rotary valve cycle, and that constant pressure is always higher than the highest pressure in the tracks below the rotor plate. The dome set pressure is based on the highest seating pressure needed for all of the positions of the rotor plate. Over time, the movement of the rotor plate causes the seal sheet to wear, which can lead to loss of performance and equipment damage.

FIGS. 2-6 illustrate one embodiment of a rotary valve. The rotary valve 15 includes two main parts: a moving rotor plate 100 and a stationary track plate 105. The rotor plate 100 is positioned on top of the track plate 105. Both the rotor plate 100 and the track plate 105 are positioned in a pressure containing vessel 110, commonly called a dome. The seal sheet 115 is secured to the bottom of the rotor plate 100 between the tracks on the track plate 105.

The track plate 105 has a plurality of track walls 155 defining a plurality of tracks 150. The annular area of each track can be determined from the track radius (based on the centerline of the track) and width. The annular area equals the exposed portion of the seal sheet above the track. There are a series of bed line ports 160 surrounding the tracks 150 around the edge of the track plate 105.

The tracks 150 are connected to the bed line ports 160 by crossover lines 165 in the rotor plate 100. The crossover lines 165 connect rotor ports 170 at the outside edge of the rotor plate 100 with rotor track openings 175 that correspond to the different tracks 150 in the track plate 105.

At the first position of the rotor plate 100, the tracks 150 are connected to the bed line ports 160 through the crossover lines 165. When the rotor plate 100 indexes to the next position, the crossover lines 165 connect the tracks to different bed line ports 160. The tracks 150 operate at different pressures based on the position of the rotor plate 100.

Pressure sensors 180 are positioned on the external rotary valve track inlet or outlet nozzles 185 to measure the actual pressure in the tracks. The measured pressure can be transmitted to a controller 190 which controls the fluid flow from the dome 110.

The seal sheet 115 is a polymer or soft metal alloy sheet which provides a seal between the rotor plate (rotor) 100 and track plate (stator) 105 of the RV. This seal sheet 115 wears over time, sometimes sooner than expected, such as in cases of extreme operation. In addition, the seal sheets 115 are sometimes torn or otherwise damaged. Premature seal sheet wear or damage can cause unexpected equipment shut-downs and production delays.

Therefore, it would be desirable to provide a way to determine the wear or damage of the seal sheet to reduce or prevent unexpected equipment shut-downs.

### BRIEF DESCRIPTION OF THE DRAWINGS

FIG. 1 is an illustration of one embodiment of an adsorption process.

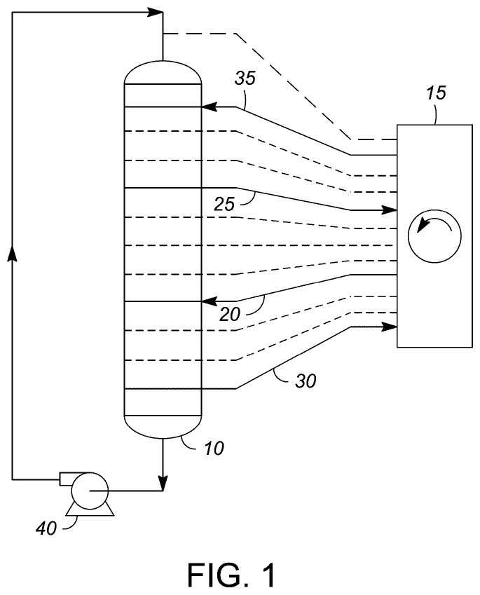

FIG. 2 is an illustration of one embodiment of the track plate and rotor plate.

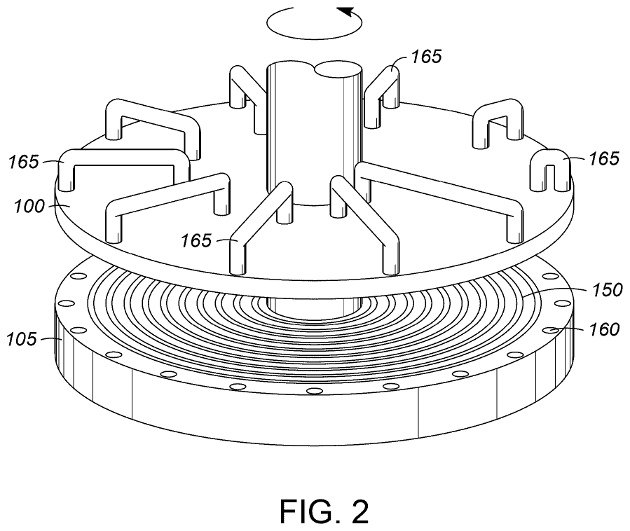

FIG. 3 is an illustration of one embodiment of an assembled rotary valve.

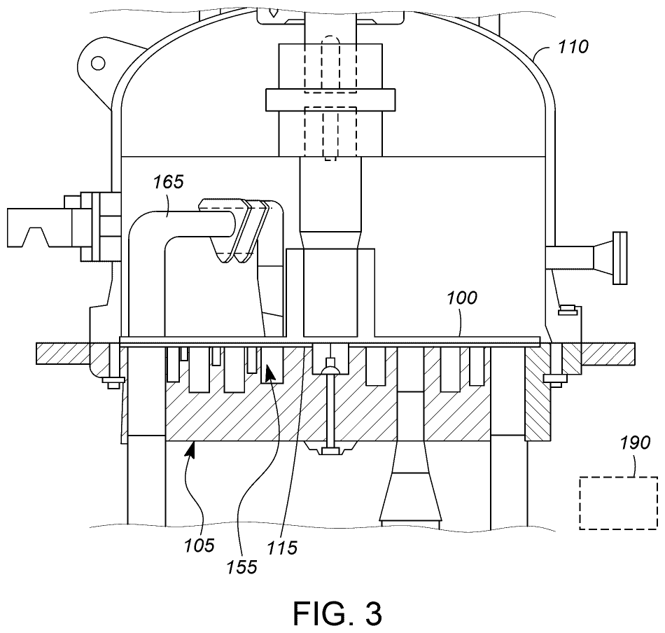

FIG. 4 is an illustration of one embodiment of a track plate.

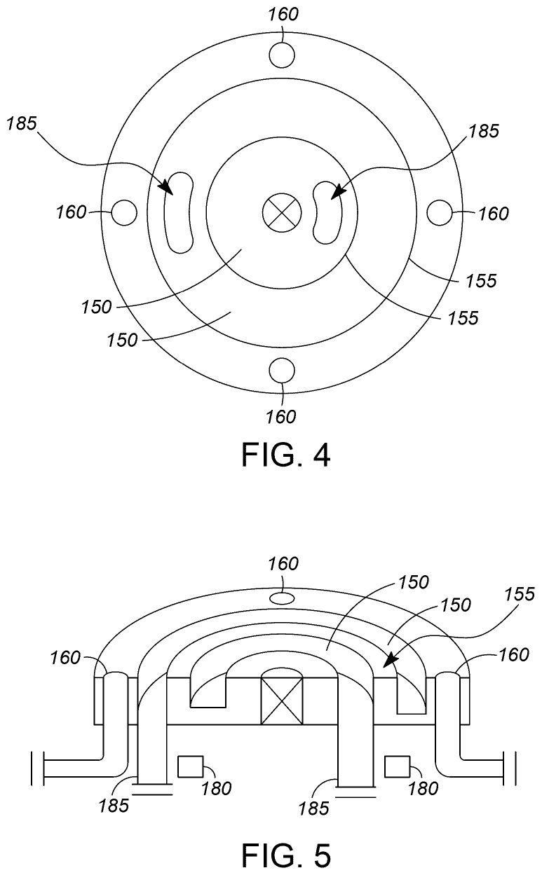

FIG. 5 is a cross-sectional perspective of the embodiment of the track plate of FIG. 4.

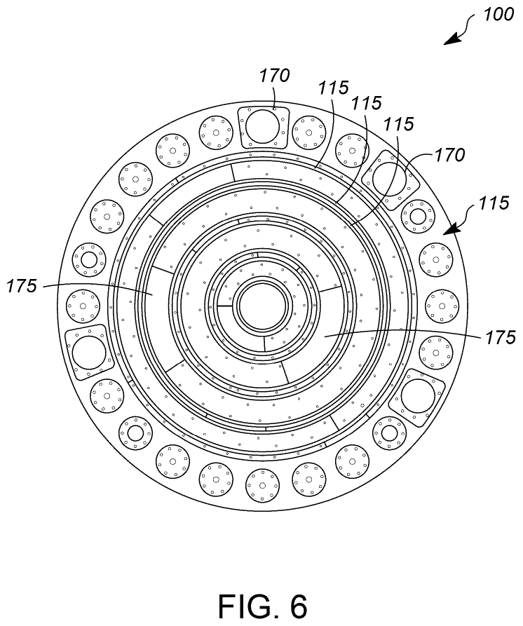

FIG. 6 is an illustration of one embodiment of the bottom of a rotor plate with the seal sheet.

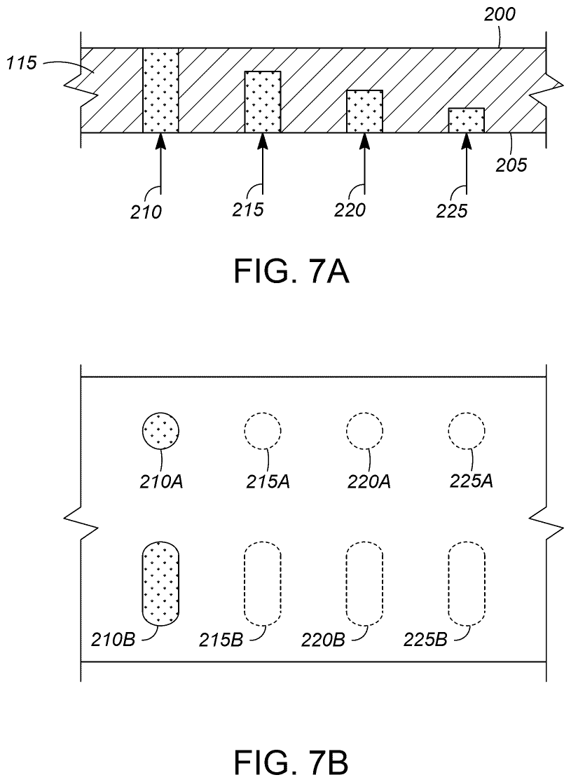

FIGS. 7A-7C illustrate one embodiment of a seal sheet with a visually contrasting design element.

FIGS. 8A-7C illustrate one embodiment of a seal sheet with a visually contrasting design element.

FIG. 9 illustrates one embodiment of a seal sheet with a series of grooves.

FIG. 10 illustrates one embodiment of a seal sheet with a groove of varying width.

### DESCRIPTION

The present invention is seal sheet with one or more wear detecting sections. The wear detecting sections provide a way to estimate the thickness of the seal sheet.

One aspect of the invention is a seal sheet made of a polymer or a soft metal alloy. At one or more points on the seal sheet, there is a wear detecting section.

The seal sheet and the wear detecting section can be made of the same material or different materials. Any suitable material that provides adequate sealing properties and wear resistance when subjected to the conditions of the process can be used. Suitable materials for the seal sheet and the wear detecting section include, but are not limited to, polytetrafluoroethylene, nitrile buna, silicone, ethylene propylene, polyurethane, fluorocarbon, fluorosilicone, neoprene, perfluoroelastomer, nitrile, soft metal alloys, or combinations thereof. A soft metal alloy is softer than the metal the track plate is made from. The softer metal will wear much faster than than the harder material. The hardness of the metal and the soft metal alloy can be measured using the Brinell hardness test, the Rockwell hardness test, or any similar hardness test. Any suitable soft metal alloy can be used. Suitable soft metal alloys include, but are not limited to, bronze, brass, copper alloys, monel, aluminum alloys, zinc alloys, and the like.

In one embodiment, the wear detecting section comprises a visually contrasting design element compared to the seal sheet, such as being different colors that are visually distinguishable from each other. For example, if the seal sheet and the wear detecting section are both made of polytetrafluoroethylene, which is typically dark gray, the wear detecting section can be a lighter color, such as white. Alternatively, the wear detecting section could be of another polymer or soft metal alloy having a color which is visually distinguishable from the material that the seal sheet is made of.

The amount of the visually contrasting design element changes as the seal sheet is used. In one embodiment, the wear detecting section can be located at various depths in the seal sheet and/or can be tapered in a way to permit seal sheet thickness measurement during operation.

For example, adding two or more (e.g., three, four, five, etc.) stripes or plugs of a color which is visually distinguishable from the color of the seal sheet at varying depths of the seal (e.g., 98% thickness, 95% thickness, 93% thickness, etc.) would allow operators to gauge the seal sheet thickness without shutting down the equipment. These indicators are placed at one or more locations around the observable circumference of the rotary valve and allow for a reasonable estimate of the thickness profile of the seal sheet.

In another embodiment, the visually contrasting design element comprises a triangular or trapezoidal cross section in the seal sheet. As the seal sheet wears, the amount of the visually contrasting design element changes. The amount of the visually contrasting design element will increase if the triangular or trapezoidal cross section is narrower at (or near) the exposed surface. Alternatively, the amount of the visually contrasting design element will decrease if the triangular or trapezoidal cross section is wider at (or near) the exposed surface. The triangular or trapezoidal cross section may or may not be exposed initially. The width of the triangular or trapezoidal cross section can be correlated to the thickness of the seal sheet.

In another embodiment, the wear detecting section comprises a groove having a width that changes during use. For example, the groove could be wider on the exposed surface of the sela sheet than it is within the seal sheet. As the seal sheet wears, the width of the groove decreases. Alternatively, the groove could be narrower at the exposed surface than with the seal sheet, and the groove would become larger with wear. The width of the groove can be correlated to the thickness of the seal sheet.

Another embodiment involves the use of at least two grooves having different depths on the exposed surface of the seal sheet. As the seal sheet wears, a portion of the exposed surface is removed. The number of grooves visible on the exposed surface can be correlated to the thickness of the seal sheet.

The wear detecting section may be observed by the operator or by a visual detector such as a camera.

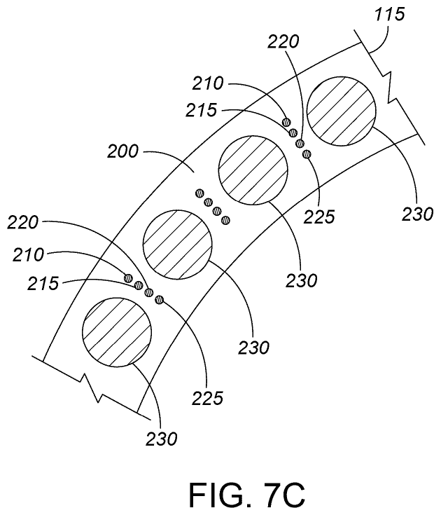

In the embodiment shown in FIGS. 7A-7C, the seal sheet 115 has an exposed surface 200 and an attachment surface 205. Four plugs or stripes 210, 215, 220, 225 of a visually contrasting design element are embedded in the seal sheet 115. As shown, the first plug or stripe extends from the attachment surface 205 to the exposed surface 200, while plugs or stripes 215, 220, and 225 extend from the attachment surface 205 only a portion of the thickness of the seal sheet 115. FIG. 7B shows a top view at the beginning of the seal sheet 115 use in which only plug or stripe 210 can be seen at the exposed surface 200 of the seal sheet 115. As the seal sheet 115 wears down, plugs or stripes 215, 220, 225 are successively exposed, giving an estimate of the thickness of the seal sheet 115.

The plugs or stripes 210, 215, 220, 225 can be any suitable shape. Suitable shapes include, but are not limited to, circular (210A, 215A, 220A, 225A), oval (210B, 215B, 220B, 225B), square (not shown), and the like.

FIG. 7C shows an illustration of a seal sheet 115 attached to the bottom of the rotor plate 100 with seal sheet washers 230. The seal sheet 115 has been worn down to expose all four plugs 210, 215, 220, 225.

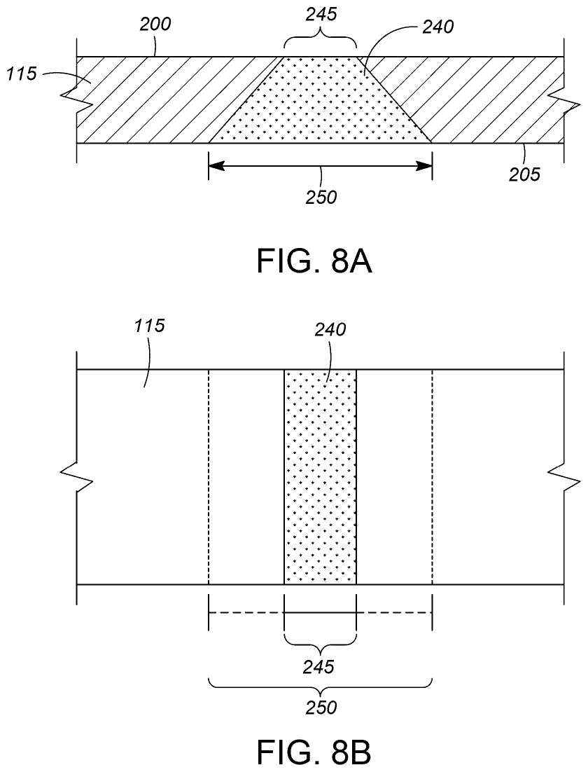

In the embodiment shown in FIGS. 8A-8C, the seal sheet 115 has an exposed surface 200 and an attachment surface 205. A tapered section 240 of a visually contrasting design element is embedded in the seal sheet 115. As shown, the tapered section 240 extends from the attachment surface 205 to the exposed surface 200 with the observable width 245 at the exposed surface 200 being greater than the width 250 at the attachment surface 205. FIG. 8B shows a top view at the beginning of the seal sheet 115 use in which only the width 245 of the tapered section 240 at the exposed surface 200 can be seen. As the seal sheet 115 wears down, the width of the tapered section 240 increases from width 245 to width 250, giving an estimate of the thickness of the seal sheet 115.

The tapered section 240 could be wider at the exposed surface 200 and narrower at the attached surface 205, in which case the width of the tapered section would decrease during use.

FIG. 8C shows an illustration of a seal sheet 115 attached to the bottom of the rotor plate 100 with seal sheet washers 230 prior to use. The seal sheet 115 has not been worn down, and the width 245 of the tapered section 240 has not been increased.

In some embodiments, the tapered section 240 may not extend all the way to the exposed surface 200.

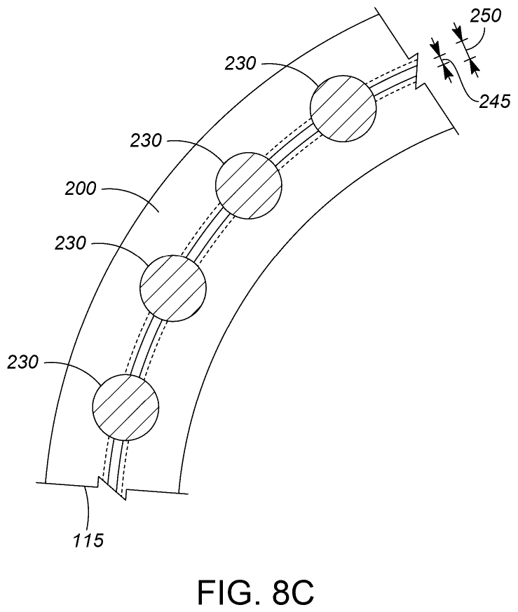

In the embodiment shown in FIG. 9, grooves 260, 265, 270, 275 are cut into the exposed surface of the seal sheet, with varying depths a, b, c, d respectively. As the seal sheet wears down to depth a, groove 260 wears away until only grooves 265, 270, 265 can be seen. Further wear to depth b erases groove 265; wear to depth c erases groove 270; and wear to depth d erases groove 275. The number of groves that can be seen can be correlated to the amount of wear of the seal sheet.

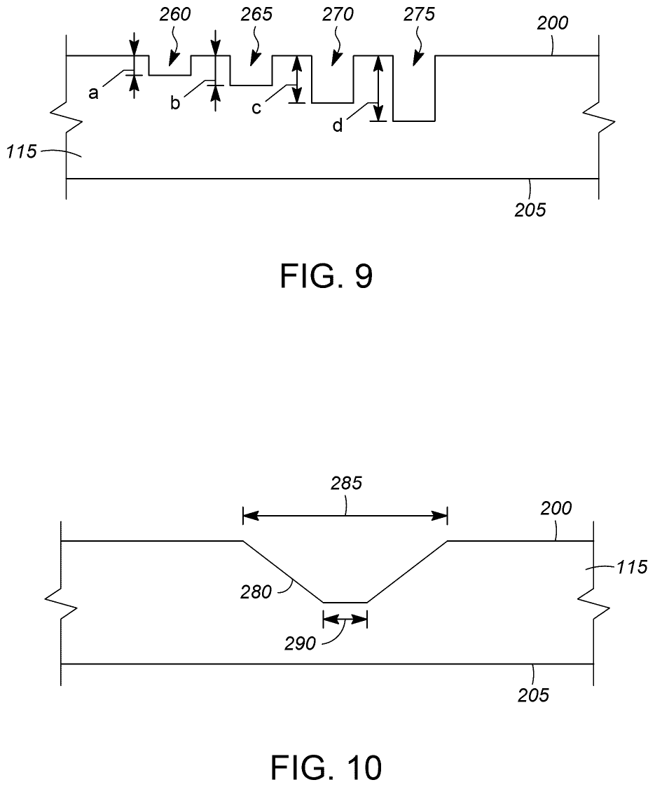

In the embodiment of FIG. 10, a groove 280 is cut in the exposed surface 200 of the seal sheet 115. The groove 280 varies from width 285 at the exposed surface 200 to width 290. As the seal sheet wears, the width will decrease from width 285 to width 295. The width of the groove 280 can be correlated to the amount of wear of the seal sheet 115.

### SPECIFIC EMBODIMENTS

While the following is described in conjunction with specific embodiments, it will be understood that this description is intended to illustrate and not limit the scope of the preceding description and the appended claims.

A first embodiment of the invention is a seal sheet comprising a sheet comprising a polymer or a soft metal alloy having an attachment surface and an exposed surface, the sheet comprising at least one wear detecting section, the wear detecting section comprising a visually contrasting design element in which an amount of the visually contrasting design element changes during use; a groove having a width that changes during use; at least two grooves having different depth wherein the number of grooves visible changes during use; or combinations thereof. An embodiment of the invention is one, any or all of prior embodiments in this paragraph up through the first embodiment in this paragraph wherein the amount of the visually contrasting design element is greater on the attachment surface than the area of the visually contrasting design element on the exposed surface. An embodiment of the invention is one, any or all of prior embodiments in this paragraph up through the first embodiment in this paragraph wherein a change in the amount of the visually contrasting design element correlates to a change in thickness of the sheet. An embodiment of the invention is one, any or all of prior embodiments in this paragraph up through the first embodiment in this paragraph wherein the visually contrasting design element is visible on the exposed surface of the sheet before use. An embodiment of the invention is one, any or all of prior embodiments in this paragraph up through the first embodiment in this paragraph wherein the visually contrasting design element comprises a triangular or trapezoidal cross section of the visually contrasting material in the seal sheet, and wherein a change in the amount of the visually contrasting design element observed correlates to a change in thickness of the seal sheet. An embodiment of the invention is one, any or all of prior embodiments in this paragraph up through the first embodiment in this paragraph wherein the visually contrasting design element comprises at least two plugs of the visually contrasting material in the seal sheet, and wherein the at least two plugs have different heights and extend from the attachment surface of the seal sheet, and wherein a change in the number of plugs visible correlates to a change in thickness of the seal sheet. An embodiment of the invention is one, any or all of prior embodiments in this paragraph up through the first embodiment in this paragraph wherein the amount of the visually contrasting design element is greater on the exposed surface than the amount of the visually contrasting design element on the attachment surface. An embodiment of the invention is one, any or all of prior embodiments in this paragraph up through the first embodiment in this paragraph wherein the wear detecting section comprises the groove having the width that changes during use, and wherein a change in the width of the groove correlates to a change in thickness of the seal sheet. An embodiment of the invention is one, any or all of prior embodiments in this paragraph up through the first embodiment in this paragraph wherein the wear detecting section comprises the at least two grooves having different depth wherein the number of grooves visible changes during use, and wherein the number of grooves visible correlates to a change in thickness of the sheet. An embodiment of the invention is one, any or all of prior embodiments in this paragraph up through the first embodiment in this paragraph wherein the sheet comprises polytetrafluoroethylene, nitrile buna, silicone, ethylene propylene, polyurethane, fluorocarbon, fluorosilicone, neoprene, perfluoroelastomer, nitrile, bronze, soft metal alloys, or combinations thereof. An embodiment of the invention is one, any or all of prior embodiments in this paragraph up through the first embodiment in this paragraph wherein the visually contrasting design element comprises polytetrafluoroethylene, nitrile buna, silicone, ethylene propylene, polyurethane, fluorocarbon, fluorosilicone, neoprene, perfluoroelastomer, nitrile, bronze, soft metal alloys, or combinations thereof. An embodiment of the invention is one, any or all of prior embodiments in this paragraph up through the first embodiment in this paragraph wherein the sheet and the visually contrasting design element comprise the same material and wherein the visually contrasting design element is a different color from the sheet. An embodiment of the invention is one, any or all of prior embodiments in this paragraph up through the first embodiment in this paragraph wherein the sheet and the visually contrasting design element comprise different materials.

A second embodiment of the invention is an apparatus comprising a stationary section having a surface; a rotating section having a surface; a seat sheet attached to the surface of the stationary section or the surface of the rotating section, the seal sheet comprising a sheet comprising a polymer or a soft metal alloy having an attachment surface and an exposed surface, the sheet comprising at least one wear detecting section, the visually contrasting design element comprising a visually contrasting material, wherein an amount of the visually contrasting design element increases or decreases during use a groove having a width that changes during use; at least two grooves having different depth wherein the number of grooves visible changes during use; or combinations thereof. An embodiment of the invention is one, any or all of prior embodiments in this paragraph up through the second embodiment in this paragraph wherein the visually contrasting design element comprises a triangular or trapezoidal cross section of the visually contrasting material in the seal sheet, and wherein a change in the amount of the visually contrasting design element correlates to a change in thickness of the seal sheet. An embodiment of the invention is one, any or all of prior embodiments in this paragraph up through the second embodiment in this paragraph wherein the visually contrasting design element comprises at least two plugs of the visually contrasting material in the seal sheet, and wherein the at least two plugs have different heights and extend from the attachment surface of the seal sheet, and wherein a change in the number of plugs visible correlates to a change in thickness of the seal sheet. An embodiment of the invention is one, any or all of prior embodiments in this paragraph up through the second embodiment in this paragraph wherein the amount of the visually contrasting design element is greater on the exposed surface than the amount of the visually contrasting design element on the attachment surface. An embodiment of the invention is one, any or all of prior embodiments in this paragraph up through the second embodiment in this paragraph wherein the wear detecting section comprises the groove having the width that changes during use, and wherein a change in the width of the groove correlates to a change in thickness of the sheet. An embodiment of the invention is one, any or all of prior embodiments in this paragraph up through the second embodiment in this paragraph wherein the wear detecting section comprises the at least two grooves having different depth wherein the number of grooves visible changes during use, and wherein the number of grooves visible correlates to a change in thickness of the sheet.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A seal sheet comprising:
a sheet comprising a polymer or a soft metal alloy having an attachment surface and an exposed surface, the sheet comprising at least one wear detecting section, the wear detecting section comprising: a visually contrasting design element in which an amount of the visually contrasting design element changes during use; a groove having a width that changes during use; at least two grooves having different depth wherein the number of grooves visible changes during use; or combinations thereof.

2. The seal sheet of claim 1 wherein the amount of the visually contrasting design element is greater on the attachment surface than the area of the visually contrasting design element on the exposed surface.

3. The seal sheet of claim 1 wherein a change in the amount of the visually contrasting design element correlates to a change in thickness of the sheet.

4. The seal sheet of claim 1 wherein the visually contrasting design element is visible on the exposed surface of the sheet before use.

5. The seal sheet of claim 1 wherein the visually contrasting design element comprises a triangular or trapezoidal cross section of the visually contrasting material in the seal sheet, and wherein a change in the amount of the visually contrasting design element observed correlates to a change in thickness of the seal sheet.

6. The seal sheet of claim 1 wherein the visually contrasting design element comprises at least two plugs of the visually contrasting material in the seal sheet, and wherein the at least two plugs have different heights and extend from the attachment surface of the seal sheet, and wherein a change in the number of plugs visible correlates to a change in thickness of the seal sheet.

7. The seal sheet of claim 1 wherein the amount of the visually contrasting design element is greater on the exposed surface than the amount of the visually contrasting design element on the attachment surface.

8. The seal sheet of claim 1 wherein the wear detecting section comprises the groove having the width that changes during use, and wherein a change in the width of the groove correlates to a change in thickness of the seal sheet.

9. The seal sheet of claim 1 wherein the wear detecting section comprises the at least two grooves having different depth wherein the number of grooves visible changes during use, and wherein the number of grooves visible correlates to a change in thickness of the seal sheet.

10. The seal sheet of claim 1 wherein the sheet comprises polytetrafluoroethylene, nitrile buna, silicone, ethylene propylene, polyurethane, fluorocarbon, fluorosilicone, neoprene, perfluoroelastomer, nitrile, bronze, soft metal alloys, or combinations thereof.

11. The seal sheet of claim 1 wherein the visually contrasting design element comprises polytetrafluoroethylene, nitrile buna, silicone, ethylene propylene, polyurethane, fluorocarbon, fluorosilicone, neoprene, perfluoroelastomer, nitrile, bronze, soft metal alloys, or combinations thereof.

12. The seal sheet of claim 1 wherein the sheet and the visually contrasting design element comprise the same material and wherein the visually contrasting design element is a different color from the sheet.

13. The seal sheet of claim 1 wherein the sheet and the visually contrasting design element comprise different materials.

14. An apparatus comprising:
a stationary section having a surface;
a rotating section having a surface; and
a seat sheet attached to the surface of the stationary section or the surface of the rotating section, the seal sheet comprising:
a sheet comprising a polymer or a soft metal alloy having an attachment surface and an exposed surface, the sheet comprising at least one wear detecting section, the wear detecting section comprising: a visually contrasting design element, wherein an amount of the visually contrasting design element increases or decreases during use: a groove having a width that changes during use; at least two grooves having different depth wherein the number of grooves visible changes during use; or combinations thereof.

15. The apparatus of claim 14 wherein the visually contrasting design element comprises a triangular or trapezoidal cross section of the visually contrasting material in the sheet, and wherein a change in the amount of the visually contrasting design element observed correlates to a change in thickness of the sheet.

16. The apparatus of claim 14 wherein the visually contrasting design element comprises at least two plugs of the visually contrasting material in the seal sheet, and wherein the at least two plugs have different heights and extend from the attachment surface of the seal sheet, and wherein a change in the number of plugs visible correlates to a change in thickness of the seal sheet.

17. The apparatus of claim 14 wherein the amount of the visually contrasting design element is greater on the exposed surface than the amount of the visually contrasting design element on the attachment surface.

18. The apparatus of claim 14 wherein the wear detecting section comprises the groove having the width that changes during use, and wherein a change in the width of the groove correlates to a change in thickness of the sheet.

19. The apparatus of claim 14 wherein the wear detecting section comprises the at least two grooves having different depth wherein the number of grooves visible changes during use, and wherein the number of grooves visible correlates to a change in thickness of the sheet.
